(19) United States
(12) Patent Application Publication
(10) Pub. No.: US 2026/0200443 A1
(43) Pub. Date: Jul. 16, 2026

(54) ELECTRIC DRIVE WITH INTEGRATED BRAKES

(71) Applicant: MAGNA Powertrain GmbH & Co KG, Lannach (AT)

(72) Inventor: Thomas Lugmayr, Neuzeug (AT)

(21) Appl. No.: 19/138,949

(22) PCT Filed: Dec. 7, 2023
(86) PCT No.: PCT/EP2023/084790

§ 371 Date: Jun. 13, 2025

(30) Foreign Application Priority Data
Dec. 21, 2022 (DE) 10 2022 214 114.8

(51) Int. Cl. B60T 1/06; B60K 1/00

(52) U.S. Cl. CPC B60T 1/062; B60K 1/00

(57) ABSTRACT

An electric drive for a vehicle includes at least one electric machine, a differential, and two brakes installed in a common housing. The brakes are disc brakes with a first and a second disc pack which are arranged on the side output shafts of the differential so as to rotate therewith and connect the side output shafts to a brake housing in the event of an actuation to apply a braking torque to the vehicle.

### CROSS-REFERENCE TO RELATED APPLICATIONS

This application is a National Stage of International Application No. PCT/EP2023/084790, filed Dec. 7, 2023, which claims priority to DE 10 2022 214 114.8, filed Dec. 21, 2022. The entire disclosures of each of the above applications are incorporated herein by reference.

### FIELD

The present disclosure relates to an electric drive for a vehicle, wherein at least one electric machine, a differential, and two brakes are installed in a common housing, wherein the brakes are multi-disc brakes.

The present disclosure also relates to a method for actuating brakes of an electric drive of a vehicle.

### BACKGROUND

This section provides information related to the present disclosure which is not necessarily prior art.

Particulate matter is one of the biggest risks to health arising from air pollution. According to estimates of many studies, particulate matter is responsible for several million deaths every year. In particular, ultra-fine particles such as rust particles are classified as carcinogenic.

Engines are only one cause of the problem as a large proportion of the particulate matter which can be measured in inner-city areas is attributable to abrasion particles. In addition to tires, the main causes of these particles are especially brake discs and brake linings.

The switch to electric cars does not change this problem at all because electric cars are also usually designed with disc or drum brakes.

Even a widespread switch to electric vehicles would thus not change this pollution level at all.

Heavy electric vehicles with a long battery range will make the problem of abrasion of brakes, tires, and the road even more pronounced.

Thus, countermeasures have to be found which reduce the abrasion of brakes and tires. Whereas emissions from combustion processes have been analyzed intensively, research into so-called non-exhaust emissions is still in its infancy. This relates in particular to the simulation of particulate matter or microplastics emissions. There currently exists no fixed standardized testing method for non-exhaust emissions of a vehicle.

In addition, there is currently no legislation on limiting or reducing non-exhaust emissions. It has, however, been announced that threshold values for brake-induced particulate matter will be legally specified.

Meanwhile, manufacturers and suppliers are looking for approaches and technical solutions for reducing the abrasion of brakes and tires. A method which enables a reduction in brake-induced particulate matter emissions will be available in future by way of the hard coating of brake discs via diode lasers. Although the coated brakes also still produce particulate matter, they do so to a much lesser extent than uncoated brake discs. The advantages of a gray cast-iron brake disc continue to exist here.

In electric vehicles, the brakes are usually configured as disc or drum brakes and placed inside the wheel arch.

A zero-emission drive unit prototype (ZEDU1) from the German Aerospace Center (DLR) is known. In this prototype, the brake system is moved from the wheel carrier into the drive unit and is integrated therewith. In combination with a specially adjusted high-performance electronics system, a high-performance battery, and a brake-by-wire (BBW) system, almost all of the braking energy can be recovered, i.e. regenerated, such that the amount of mechanical braking is minimized. This makes it possible for the drive unit to have a very compact structure, to integrate it into the gearbox/brake unit and to completely eliminate emissions from brake abrasion. In the ZEDU1, a multi-disc brake is integrated directly into the electric motor. Together with the high-performance electronics system, it ensures almost complete recovery of the drive energy. The brake abrasion thus lands in an oil bath, the contents of which are continually pumped through a filter and cleaned.

### SUMMARY

This section provides a general summary of the disclosure, and is not a comprehensive disclosure of its full scope or all of its features.

The object of the present disclosure is to present an improved electric axle for a vehicle with integrated brakes which are integrated into the electric drive unit, wherein the problems known from the prior art are largely avoided.

The object is achieved with an electric drive for a vehicle, wherein at least one electric machine, a differential, and two brakes are installed in a common housing, wherein the brakes are multi-disc brakes which are arranged in co-rotating fashion on the side driven shafts of the differential and, when actuated, connect the side driven shafts to a brake housing in order to apply a brake torque to the vehicle.

In the case of an open brake, the brake rotates completely at the output shaft speed (revolution of the whole brake) of the side driven shafts and thus generates almost no drag losses compared with conventional brake systems. This situation corresponds to the neutral position.

The brake advantageously comprises a synchronizer unit. Synchronizer units are used in motor vehicles, for example in gearboxes, in different variants and are known in principle to a person skilled in the art. They serve to adapt the rotational speed between the elements to be coupled and thus to reduce the shifting force and the wear. A known variant here is a cone friction clutch. One or more friction cones can be present depending on the torque to be synchronized. A distinction is made between single-cone synchronization and multi-cone synchronization according to the number of cones.

In a preferred embodiment of the brake, the synchronizer unit is configured as a single-cone synchronizer. The cone friction clutch of the synchronizer unit is formed between a first synchronizer ring and a second synchronizer body.

An actuating piston applies a force to a hub which is arranged on the side driven shaft so that it is axially displaceable but non-rotatable. It is supported on the first disc carrier via axial bearings. The first disc carrier is coupled to a synchronizer ring such that, by way of an axial shifting of the synchronizer ring, it comes into frictional engagement with a synchronizer body fixed to the housing and establishes a frictional connection to the brake housing. The first disc carrier can be fixed to the housing in the operating position via the synchronizer unit.

The second set of discs can be connected to the first set of discs and the side driven shafts via the actuating piston.

The object is also achieved by a method for braking an electric drive, wherein the open brake rotates with the two sets of discs with the side driven shafts and, when the brake is actuated in two successive displacement steps, the sets of discs are connected to the brake housing.

In a first step of the method, via actuation of a hub which is non-rotatable but axially displaceable on the side driven shaft, synchronization of the co-rotating first disc carrier with the first set of discs is first effected, starting from the output rotational speed of the driven shaft of the differential to the rotational speed 0. After the synchronization, the first disc carrier is frictionally fixed via the synchronizer ring on the synchronizer body connected to the brake housing.

In the following second method step, the alternatingly arranged discs of the first and second set of discs are displaced axially by continuing actuation and are brought into frictional contact with one another. A corresponding brake torque is generated depending on the continuing actuating force.

No oiling is provided in the case of open brakes in the neutral position but in the case of a closed brake, the sets of discs are oiled through an oil bore along the side driven shaft and a bore in the displaceable hub.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure. In the drawings:

FIG. 1 shows a brake of the electric drive on a side driven shaft,

FIG. 2 shows schematically the structure of the electric drive,

FIG. 3 shows the unactuated brake (neutral position) in a schematic illustration in an axial section,

FIG. 4 shows an actuated brake in a first actuated state in a simplified schematic illustration; and

FIG. 5 shows an actuated brake in a second actuated state in a simplified schematic illustration.

### DETAILED DESCRIPTION

FIG. 2 shows an electric drive unit 1 which contains an electric machine 20. This electric machine 20 is actively coupled to a reduction gearbox (not illustrated) which has a gear stage. The gearbox output shaft 20a drives a differential 21. The driven shafts 21a, 21b of the differential 21 are connected to the side driven shafts 8. As can be seen from the schematic illustration in FIG. 2, brakes 22 are arranged on both sides of the differential 21 in a symmetrical arrangement. When actuated accordingly, the brakes transmit a brake torque to the side driven shafts 8. The side driven shafts 8 drive the wheels 23 of the vehicle.

The components the electric machine 20 with a reduction gearbox, the differential 21, and the brakes 22 are installed in a common housing 6 and form a module.

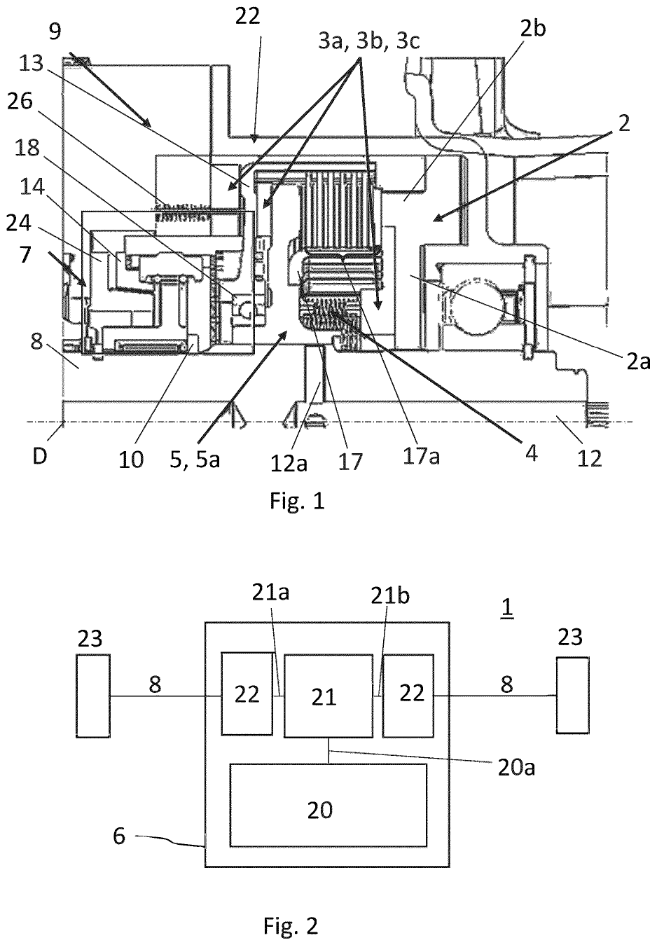

FIG. 1 shows the brake 22 of one side of the electric drive unit 1 in an axial section in a schematic illustration in the open state. This open state in which no brake torque is transmitted corresponds to the neutral position.

The brake 22 on only one side of the differential 21 will now be described below. The brake on the opposite other side of the differential on the side driven shaft 8 is correspondingly constructed symmetrically.

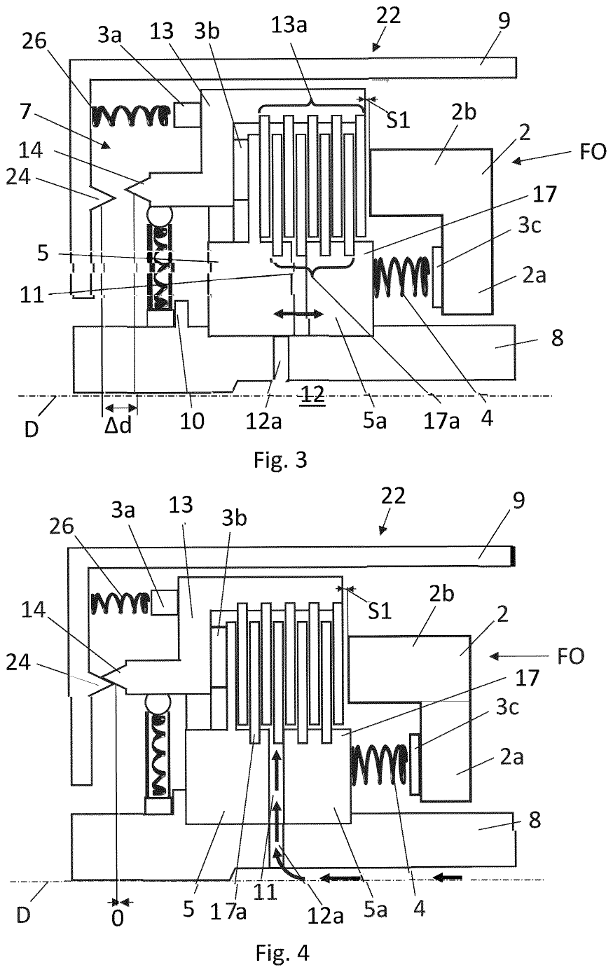

FIG. 3 also shows the brake 22 in the open state/neutral position in a highly simplified schematic illustration. The illustration shows only a subsection of the brake. The axis of rotation D of the side driven shaft 8 is indicated in the FIGs.

The direction along the axis of rotation D is referred to below as the axial direction.

The brake 22 has a first disc carrier 13 with a first set of discs 13a and a second disc carrier 17 with a second set of discs 17a. The first and second set of discs 13a, 17a are arranged so that they engage with each other in such a way that the discs of the first set of discs 13a and the second discs of the second set of discs 17a are arranged next to one another and alternatingly, in the axial direction. In the neutral position, a gap is situated between the first and second discs, in the axial direction. In the actuated position, a frictional connection is established between the alternatingly arranged discs of the first and second set of discs by axial displacement of the discs. This fundamental structure and the arrangement of the sets of discs and disc carriers are known from the prior art and are not described in detail at this point.

The first disc carrier 13 is preferably the outer disc carrier, in the radial direction. The second disc carrier 17 is then correspondingly the inner disc carrier. The first disc carrier 13 is mounted on the second disc carrier 17 via a radial bearing 18.

The second disc carrier 17 is fixed on a hub 5. In an alternative embodiment which is illustrated schematically in FIGS. 3-5, the second disc carrier 17 is formed by a hub 5.

The hub 5 is arranged non-rotatably on the side driven shaft 8 in order to transmit a torque. The hub 5 is mounted on the side driven shaft 8 so that it is displaceable in the axial direction. A known embodiment of such a hub 5 is a splined hub 5a which is arranged in form-fitting fashion on the side driven shaft 8 via splines and is axially displaceable on the side driven shaft 8 owing to the form-fitting interengaging splined connection between the splined hub 5a and the side driven shaft 8. The axial displaceability of the hub 5 is indicated by the double-headed arrow.

Radial oil bores 11 are introduced into the hub 5 as through bores which run from an outer cylindrical surface of the hub 5 to a radially inner cylindrical surface of the hub 5.

The side driven shaft 8 also contains an oil bore 12. The oil bore 12 is configured so that it runs from one end side of the side driven shaft 8 initially in an axial direction and then branches into a large number of radial bores 12a. The radial bores 12a extend from the axial oil bore 12 to the surface of the side driven shaft 8 and thus enable the supply of oil to the outer cylindrical surface of the side driven shaft 8 in the region of the outlet openings of the radial bores 12a. In the neutral position of the brake 22 shown in FIG. 3, the hub 5 is arranged on the side driven shaft 8 in such a way that the radial bores 12a are covered by the inner cylindrical surface of the hub 5.

The brake 22 furthermore has a synchronizer unit 7 which is configured as a single-cone synchronizer. The cone friction clutch with friction linings of the synchronizer unit is formed between a synchronizer ring 14 and a synchronizer body 24. This type of synchronization is known from the prior art and will not be described in detail at this point.

The synchronizer body 24 is arranged fixed to the housing. The synchronizer ring 14 is coupled directly or indirectly to the first disc carrier 13.

In the neutral position of the brake 22, the synchronizer ring 14 has a spacing Ad, in the axial direction, from the synchronizer body arranged fixed to the housing.

The first disc carrier 13 is mounted so that it is supported on both sides via axial bearings 3a, 3b. The axial bearing 3a supports the first disc carrier 13 on the brake housing 9 with the interposition of a spring 26. The second axial bearing 3b mounts, in the axial direction, the first disc carrier 13 on the second disc carrier 17 or on the first fixedly arranged disc of the second set of discs 17a.

The brake 22 furthermore comprises an actuating piston 2 which is preferably actuated hydraulically. The actuation system is not illustrated in the drawings and described in detail. The actuating piston 2 has a radial portion 2a and an actuating portion 2b extending axially at an upper end portion of the radial portion 2a. The actuating portion 2b extends in the direction of the first and second sets of discs 13a and 13b arranged nested inside each other. In the neutral position, a gap with the spacing S1 is situated between the actuating portion 13a of the actuating piston 2 and the first set of discs 13a or the first outwardly situated disc, in an axial direction.

The actuating piston 2 is supported on an end side of the hub 5 via an axial bearing 3c with the interposition of a spring 4. The actuating piston 2 is axially displaceable by imparting an actuating force which is illustrated by the arrow F0.

The spring constant of the spring 4 is greater than the spring constant of the spring 26.

If the brake 22 is open in the neutral position, the sets of discs of the brake 22 are not oiled by the covered oil bore 12/radial bores 12a. Oiling can, however, also take place via an external supply and control system.

When the brake is actuated, a force F0 is applied to the actuating piston 2 such that the actuating piston 2 is displaced axially. In a first step, a force is initially transmitted to the hub 5 in the case of the axial displacement and application of force in the direction of the arrow F0 via the axial bearing 3c. This first method step is illustrated in FIG. 4. In this situation, the hub 5 is, as can be seen in the drawings, displaced axially and the radial bore 11 is brought to overlap the radial bores 12a such that the supply of oil to the sets of discs is ensured. The hub 5 bears axially against an axial stop 10 on the side driven shaft 8 and cannot be displaced further axially.

The further flow of force takes place via the axial bearing 3b onto the first disc carrier 13 and the synchronizer ring 14 of the synchronizer unit 7. The axial displacement of the hub 5 causes an axial displacement of the synchronizer ring 14 counter to the spring force of the spring 26. The synchronizer ring 14 comes into frictional active connection with the synchronizer body 24. Once synchronization is complete in the first method step shown, the first disc carrier 13 is connected fixedly to the housing 9 via the synchronizer unit 7 and thus braked to zero speed. The axial displacement in the first method step corresponds to the displacement Ad.

In this situation after the first method step (the first disc carrier 13 is coupled fixedly to the brake housing 9), the actuating piston 2 or the axial actuating portion 13a is furthermore arranged spaced apart by the gap S1 from the first set of discs of the first disc carrier 13.

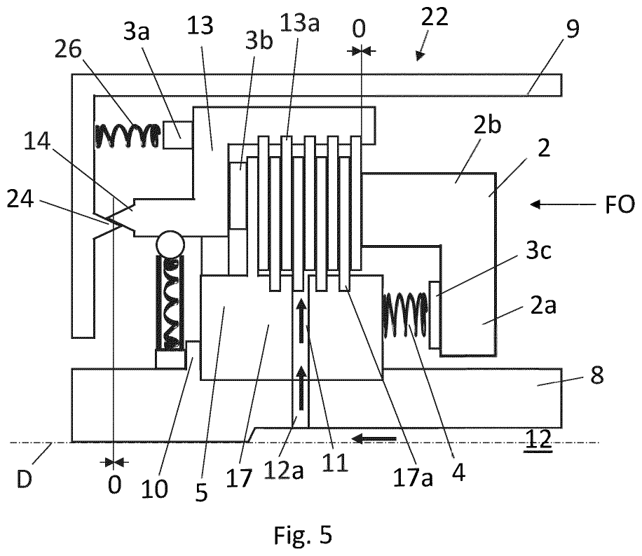

In the second method step shown in FIG. 5, the actuating portion 13a is, via further displacement of the actuating piston 2 after a displacement by the axial distance +, brought to bear against the outer disc of the first set of discs 13a such that an actuating force is exerted on the first set of discs 13a. As a result, the gaps between the alternatingly arranged discs of the first and second sets of discs 13, 17 are closed by the frictional connection between the two sets of discs and a brake torque can thus be generated.

The spring 4 is compressed by the above described “closing” of the brake 22 in the second method step and the hub 5 is supported, spring-loaded, on the stop 10. Because the hub 5 is arranged non-rotatably on the side driven shaft 8 and the frictionally actively connected sets of discs are supported, fixed on the housing, via the first disc carrier 13 and the synchronizer unit 7, the brake torque is applied to the side driven shaft 8.

The brake 22 is illustrated in the closed state in FIG. 5.

When the brake 22 is open, the braking force is first reduced and then the synchronizer unit 7 is opened by the spring force of the spring 26. After the first disc carrier 13 has been uncoupled from the brake housing 9, the first disc carrier 13 can rotate again, freely co-rotating by virtue of the drag torque that exists and the radial mounting on the second disc carrier 17.

The oil is pumped to a filter by way of a pump in order to filter out any abrasion particles. Oxidative particulate matter in the environment is avoided as a result.

### LIST OF REFERENCE SIGNS

1 electric axle drive
2 actuating piston
2a radial portion of actuating piston
2b axial portion/actuating portion
3a-3c axial bearings
4 spring
5 hub
5a splined hub
6 housing
7 synchronizer unit
8 side driven shaft
9 brake housing
10 stop
11 bore
12 oil bore
12a radial bore
13 first disc carrier
13a first set of discs
14 synchronizer ring
17 second disc carrier
18 radial bearing
17a second set of discs
20 electric machine including gear stage
21 differential
22 brake
23 wheel
24 synchronizer body
26 spring

1. An electric drive for a vehicle, the electric drive comprising:
at least one electric machine, a differential, and two brakes installed in a common housing,
wherein the brakes are multi-disc brakes with a first and a second disc carrier having associated first and second sets of discs, and
wherein the brakes include a brake housing,
wherein the first and second disc carriers are arranged in co-rotating fashion on the side driven shafts of the differential and, when actuated, connect the side driven shafts the a brake housing to apply a brake torque to the vehicle.

2. The electric drive for a vehicle, wherein, when actuated, an actuating force is applied to the first set of discs via an axially displaceably mounted actuating piston, and
wherein the actuating piston is supported indirectly or directly on the second disc carrier via an axial bearing with a spring disposed between the second disc carrier and the actuating piston.

3. The electric drive as claimed in claim 1, wherein each brake includes a synchronizer unit, wherein the second disc carrier is arranged indirectly or directly on the side driven shaft so that it is axially displaceable but non-rotatable, wherein the first disc carrier is mounted by way of a radial bearing on the second disc carrier.

4. The electric drive as claimed in claim 1, wherein the second disc carrier fixedly connected to a hub or integrally formed with the hub, wherein the hub is arranged axially displaceably but non-rotatably on the side driven shaft.

5. The electric drive as claimed in claim 4,
wherein each the brake includes a synchronizer unit with a synchronizer ring and a synchronizer body,
wherein the synchronizer body is fixedly attached to the brake housing and the synchronizer ring is attached to the first disc carrier, and
wherein, when an actuating force is applied to the hub via the actuating piston, a frictional connection is established between the synchronizer ring and the synchronizer body to obtain non-rotatable fixing of the first disc carrier to the brake housing.

6. The electric drive as claimed in claim 1, wherein for each brake the second set of discs is connected to the first set of discs and the side driven shaft via actuation of the actuating piston.

7. The electric drive as claimed in claim 5, wherein the synchronizer unit is a single-cone synchronizer.

8. A method for braking an electric drive as claimed in claim 1, the method comprising:
for an open brake of the brakes, positioning the open brake in a neutral position, with the first and second disc carriers having the associated sets of discs rotating with the side driven shaft and,
actuating the open brake in two successive displacement steps, and
connecting the first and second sets of discs to the brake housing and defining a closed brake; and
generating a brake torque.

9. The method as claimed in claim 8, wherein the first disc carrier with the first set of discs is, in a first method step of the successive method steps, initially fixed to the brake housing via the synchronizer unit and, in a further method step of the successive method steps, alternatingly arranged discs of the two sets of discs are brought into frictional contact with one another.

10. The method as claimed in claim 8,
wherein no oiling of the sets of discs takes place in the case of the open brake in the neutral position;
wherein, in the case of the brake being defined as a closed brake, the sets of discs are oiled through an oil bore formed in the side shaft and branching radial bores extending therefrom along the side driven shaft, wherein the branching radial bores are put into fluid communication with a radial bore formed in an axially displaceably mounted hub that is connected to the second set of discs.

11. The electric drive as claimed in claim 4, wherein the hub is a splined hub arranged in a form-fitting fashion on corresponding splines of the side driven shaft.

12. The electric drive as claimed in claim 1, wherein, for each brake, when the brake is a neutral position and the sets of discs are not engaged with each other and are also disengaged from the brake housing, the second rotates completely at the speed of the side driven shaft.

13. The electric drive as claimed in claim 1,
wherein the first disc carrier is supported on both sides by axial bearings, including a first axial bearing disposed between the first disc carrier and the brake housing, and a second axial bearing disposed between the first disc carrier and the second disc carrier.

14. The electric drive as claimed in claim 13,
wherein a first spring is disposed between the brake housing and the first axial bearing and biases the first disc carrier away from engagement with the brake housing;
where an actuating piston is disposed axially adjacent an axially outer disc of the first set of discs, wherein a gap is defined between the actuating piston and the axially outer disc in a neutral position of the brake;
wherein a hub having the second set of discs fixed relatively thereto is splined and attached to the side drive shaft and axially moveable relative to the side driven shaft, wherein a second spring is disposed axially between the actuating piston and the hub, wherein the second spring biases the actuating piston away from the first and second sets of discs.

15. The electric drive as claimed in claim 14, wherein the hub includes at least one radial oil bore in the form of a through-bore, wherein the side driven shaft includes an axial oil bore having a plurality of branching radial bores branching therefrom to a surface of the side driven shaft, wherein an inner cylindrical surface of the hub extends axially over the branching radial bores of the side driven shaft.

16. The electric drive as claimed in claim 15, wherein when the brake is in the neutral position, the branching radial bores are blocked by the hub, wherein the when the brake is actuated into a closed position, the radial oil bore of the hub is in fluid communication with at least one of the branching radial bores of the side driven shaft.

17. The electric drive as claimed in claim 14,
wherein initial actuation of the piston toward the first and second sets of discs initially shifts the hub via the second spring, wherein the second disc carrier shifts the first disc carrier via the second axial bearing and against the bias of the first spring, which shifts the first disc carrier into engagement with the brake housing;
wherein further actuation of the piston toward the first and second sets of discs shifts the piston into contact with the with the axially outer disc of the first set of discs, and shifts the first set of discs into engagement with the second set of discs and opens a gap at the second axial bearing, such that the first disc carrier and second disc carrier are connected via the sets of discs and the side driven shaft is connected to the brake housing via the first and second disc carriers and the first and second sets of discs.

18. The electric drive as claimed in claim 17, wherein the actuating piston has an actuating portion and a radial portion, wherein the actuating portion contacts the axially outer disc of the first set of discs and the radial portion bears against the second spring via a third axial bearing.

19. The electric drive as claimed in claim 18, wherein the spring constant of the second spring is greater than the spring constant of the first spring.
